(19) United States
(12) Patent Application Publication
(10) Pub. No.: US 2026/0332621 A1
(43) Pub. Date: Oct. 22, 2026

(54) DYNAMIC SECURITY BROKER FOR CLOUD SIGNALS

(71) Applicant: Brava Security, LTD, Tel Aviv (IL)

(72) Inventors: Idan BASRE, Tel Aviv (IL); Itay GABBAY, Tel Aviv (IL)

(73) Assignee: Brava Security, LTD, Tel Aviv (IL)

(21) Appl. No.: 19/186,126

(22) Filed: Apr. 22, 2025

(51) Int. Cl. H04L 9/40; H04L 67/10

(52) U.S. Cl. CPC H04L 63/1425; H04L 63/1433; H04L 63/20; H04L 67/10

(57) ABSTRACT

A system and method for optimizing a security information and event management (SIEM) tool is presented. The method includes receiving cloud logs, wherein cloud logs are logs of events captured from a cloud environment; applying routing logic to cloud logs to determine a target storage, wherein a target storage includes either a SIEM tool or a low-cost tiered storage, wherein the low-cost tiered storage is external to the SIEM tool; and storing, in the target storage, the cloud logs based on the application of the routing logic to the cloud logs.

### TECHNICAL FIELD

The present disclosure relates generally to Security Information and Event Management (SIEM), and, more specifically, to optimizing SIEM for cloud computing environments.

### BACKGROUND

A SIEM (Security Information and Event Management) tool is designed to collect, monitor, and analyze security events and logs in real time. The primary function of a SIEM tool is to provide security teams with insights into potential security threats by aggregating logs from various data sources across an organization's infrastructure. These sources can include endpoints, servers, firewalls, network devices, applications, and cloud environments. SIEM tools help identify patterns, detect anomalies, and offer a centralized point for investigating security incidents.

When collecting logs from endpoints and cloud environments, SIEM tools typically rely on agents or integrations to capture data from these sources. For cloud environments, SIEM tools can ingest logs from cloud services, such as AWS CloudTrail®, Azure Security Center®, Google Cloud Logging®, and similar platforms. These logs often capture critical information about user activity, resource usage, security events, and configuration changes. The SIEM tool aggregates the logs to provide a comprehensive view of the security landscape across the entire network.

However, processing cloud logs for use by a SIEM tool presents certain challenges. One issue is that SIEM tools often become overwhelmed with the volume of logs and events, and the fact that the volume of logs and events are redundant or infrequently used. As a result, security teams must analyze vast amounts of data without finding actionable insights.

Further, in cloud environments, logs and data that are no longer actively used are sometimes moved to cold storage for long-term retention. SIEM tools are typically optimized for accessing real-time or frequently accessed data, and retrieving logs from cold storage can introduce significant delays. When an incident occurs, it may be critical to access these older logs for forensic purposes, but the retrieval process can be slow, and this latency can hinder timely investigations.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include receiving cloud logs, where cloud logs are logs of events captured from a cloud environment. The method may also include applying routing logic to cloud logs to determine a target storage, where a target storage includes either a SIEM tool or a low-cost tiered storage, where the low-cost tiered storage is external to the SIEM tool. The method may furthermore include storing, in the target storage, the cloud logs based on the an application of the routing logic to the cloud logs. Other embodiments of this aspect include corresponding computer systems, apparatus, and computer programs recorded on one or more computer storage devices, each configured to perform the actions of the methods.

Implementations may include one or more of the following features. The method where applying the routing logic to cloud logs to determine the target storage further may include: determining the target storage based on at least one of: security detection and response procedures, a level of security severity of cloud logs, and querying history. The method where determining the target storage based on the level of security severity of cloud logs further may include: receiving security data from threat intelligence feeds and information on the cloud environment; determining a level of security severity of each cloud log based on the received security data from threat intelligence feeds and information on the cloud environment; when the level of security severity of the cloud log is above a pre-determined threshold, routing the cloud log to the SIEM tool; and when the level of security severity of the cloud log is below a pre-determined threshold, preparing the cloud logs to be stored in the low-cost tiered storage. The method may include: updating the determined level of security severity of each cloud log based on newly received security data from threat intelligence feeds and information on the cloud environment. The method where preparing the cloud logs to be stored in the low-cost tiered storage further may include: for cloud logs of the same type, aggregating a set of cloud logs when the a size of cloud logs in the set reaches a pre-determined threshold; compressing each aggregated set of cloud logs into at least one file, where the at least one file is a column-based file; extracting indicators relevant for querying the cloud logs; modifying the a schema of the cloud logs based on the extracted indicators to enable efficient retrieval of the cloud logs from the low-cost tiered storage; and storing the cloud logs in tiers, where tiers store cloud logs based on the a frequency of access of the cloud logs. The method where the extracted indicators include time-based indicators and location-based indicators associated with data in the cloud logs. The method where storing the cloud logs in tiers further may include: computing probabilities of frequency of access of the cloud logs based on the a determined patterns in queries; when the a determined probability of frequency of access of the cloud log is sufficiently high, storing the cloud log in a first tier; and when the determined probability of frequency of access of the cloud log is insufficiently high, storing the cloud log in a second tier. The method where determining the target storage based on security detection and response procedures further may include: determining when a set of cloud logs collected by a SIEM tool is collected as part of an organization's security incidents and response procedures; and when a set of cloud logs collected by a SIEM tool is collected as part of an organization's security incidents and response procedures, keeping the set of cloud logs in the SIEM tool. The method where determining the target storage based on a querying history further may include: determining when a set of cloud logs collected by the SIEM tool is part of at least one query previously submitted to the SIEM tool; and when a set of cloud logs collected by the SIEM tool is part of at least one query, keeping the set of cloud logs in the SIEM tool. The method where the routing logic is applied using a machine learning (ML) model trained on security data from threat intelligence feeds and information about a plurality of cloud environments. Implementations of the described techniques may include hardware, a method or process, or a computer-tangible medium.

In one general aspect, a non-transitory computer-readable medium may include one or more instructions that, when executed by one or more processors of a device, cause the device to: receive cloud logs, where cloud logs are logs of events captured from a cloud environment; apply routing logic to cloud logs to determine a target storage, where a target storage includes either a SIEM tool or a low-cost tiered storage, where the low-cost tiered storage is external to the SIEM tool; and store, in the target storage, the cloud logs based on the an application of the routing logic to the cloud logs. Other embodiments of this aspect include corresponding computer systems, apparatus, and computer programs recorded on one or more computer storage devices, each configured to perform the actions of the methods.

In one general aspect, a system may include a processing circuitry. The system may also include a memory, the memory containing instructions that, when executed by the processing circuitry, configure the system to: receive cloud logs, where cloud logs are logs of events captured from a cloud environment. The system may in addition apply routing logic to cloud logs to determine a target storage, where a target storage includes either a SIEM tool or a low-cost tiered storage, where the low-cost tiered storage is external to the SIEM tool. The system may moreover store, in the target storage, the cloud logs based on the an application of the routing logic to the cloud logs. Other embodiments of this aspect include corresponding computer systems, apparatus, and computer programs recorded on one or more computer storage devices, each configured to perform the actions of the methods.

Implementations may include one or more of the following features. The system where the memory contains further instructions that, when executed by the processing circuitry for applying the routing logic to cloud logs to determine the target storage, further configure the system to: determine the target storage based on at least one of: security detection and response procedures, a level of security severity of cloud logs, and query history. The system where the memory contains further instructions that, when executed by the processing circuitry for determining the target storage based on the level of security severity of cloud logs, further configure the system to: receive security data from threat intelligence feeds and information on the cloud environment; determine a level of security severity of each cloud log based on the received security data from threat intelligence feeds and information on the cloud environment; when the level of security severity of the cloud log is above a pre-determined threshold, route the cloud log to the SIEM tool; and when the level of security severity of the cloud log is below a pre-determined threshold, prepare the cloud logs to be stored in the low-cost tiered storage. The system where the memory contains further instructions which when executed by the processing circuitry further configure the system to: update the a determined level of security severity of each cloud log based on newly received security data from threat intelligence feeds and information on the cloud environment. The system where the memory contains further instructions that, when executed by the processing circuitry for preparing the cloud logs to be stored in the low-cost tiered storage, further configure the system to: for cloud logs of the same type, aggregate a set of cloud logs when the a size of cloud logs in the set reaches a pre-determined threshold; compress each aggregated set of cloud logs into at least one file, where the at least one file is a column-based file; extract indicators relevant for querying the cloud logs; modify the a schema of the cloud logs based on the extracted indicators to enable efficient retrieval of the cloud logs from the low-cost tiered storage; and store the cloud logs in tiers, where tiers store cloud logs based on the a frequency of access of the cloud logs. The system where the memory contains further instructions that, when executed by the processing circuitry for storing the cloud logs in tiers, further configure the system to: compute probabilities of frequency of access of the cloud logs based on the a determined patterns in queries; when the a determined probability of frequency of access of the cloud log is sufficiently high, store the cloud log in a first tier; and when the determined probability of frequency of access of the cloud log is insufficiently high, store the cloud log in a second tier. The system where the memory contains further instructions that, when executed by the processing circuitry for determining the target storage based on security detection and response procedures, further configure the system to: determine when a set of cloud logs collected by a SIEM tool is collected as part of an organization's security incidents and response procedures; and when a set of cloud logs collected by a SIEM tool is collected as part of an organization's security incidents and response procedures, keep the set of cloud logs in the SIEM tool. The system where the memory contains further instructions that, when executed by the processing circuitry for determining the target storage based on a querying history, further configure the system to: determine when a set of cloud logs collected by the SIEM tool is part of at least one query previously submitted to the SIEM tool; and when a set of cloud logs collected by the SIEM tool is part of at least one query, keep the set of cloud logs in the SIEM tool. The system where the routing logic is applied using a machine learning (ML) model trained on security data from threat intelligence feeds and information about a plurality of cloud environments. Implementations of the described techniques may include hardware, a method or process, or a computer-tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 shows an example network diagram utilized to describe the various disclosed embodiments.

FIG. 2 is an example functional diagram illustrating SIEM optimization according to an embodiment.

FIG. 3 is an example flowchart of a process for optimizing a SIEM tool according to an embodiment.

FIG. 4 is an example flowchart illustrating a process for dynamic routing of logs to SIEM tool according to an embodiment.

FIG. 5 is an example flowchart illustrating a process for preparing cloud logs for storage to enable efficient retrieval of the cloud logs according to an embodiment.

FIG. 6 is an example schematic diagram of a security broker according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for optimizing a SIEM tool. The disclosed system includes a dynamic security broker configured to collect or otherwise receive cloud-based logs and events and dynamically routes the flow of logs, ensuring that non-security logs and infrequently-used logs are routed to tiered cloud storage (hereinafter “storage”) and that meaningful logs are routed to a SIEM tool. By leveraging dynamic log management, the disclosed security broker automatically prioritizes the logs that are most relevant for security monitoring, reducing noise and making it easier for security teams to detect potential security incidents. This adaptive routing serves to reduce the computer resource usage required by a SIEM tool by routing meaningful (e.g., high security severity) logs of the full set of logs generated in a cloud environment.

Additionally, the disclosed security broker compresses, aggregates, and intelligently indexes infrequently-used logs and non-security logs in storage to allow for on-demand retrieval of such logs from storage when necessary. The techniques used to prepare logs to be saved in storage allows for security researchers to query such logs more efficiently and quickly to allow for faster, more accurate identification of logs that are relevant to potential security threats through the analysis of such logs. In traditional systems, hundreds of thousands of files each containing, for example, one kilobyte of log data in, for example, one minute are stored. Storing a multitude of small, individual files requires high storage costs and are difficult to retrieve, leading to further inefficiencies and computational costs. The disclosed embodiments aggregate the logs and store the aggregated logs in far fewer files than traditionally required and in optimal file sizes, which enables a significant reduction in computer resource usage. The disclosed embodiments provide for modifying the schema of these files to be indexed more efficiently in storage, which allows more efficient retrieval of the logs, ensuring further computational cost savings.

Furthermore, the human mind is not equipped to perform the disclosed embodiments of the present disclosure in a reliable, objective way because the human mind cannot perform the disclosed embodiments to increase procurement likelihood and customer retention through machine learning techniques, including the use of the Large Language Models (LLMs) as disclosed herein. The human mind is not equipped to perform the operations of machine learning techniques.

Further, the human mind is not equipped to dynamically route logs and index compressed, aggregated logs in an objective manner because the human mind applies subjective criteria that may vary over many repetitions, leading to inconsistent results, and may vary between different human operators.

Moreover, the human mind cannot practically perform the disclosed embodiments because a human operator cannot practically analyze and operate on, using paper and pencil, the copious amount of logs collected from a cloud environment as performed as part of the disclosed embodiments to route logs based on level of security severity and index logs in cold storage. In a typical enterprise environment, thousands of logs are generated per day. It is expected that as the number of compute devices increases, the number of generated logs will exponentially grow. A human operator would impractically perform the disclosed embodiments such that the results would not be achieved at the speeds and accuracy required to operably route logs dynamically and compress, aggregate, and index logs in cold storage as disclosed herein.

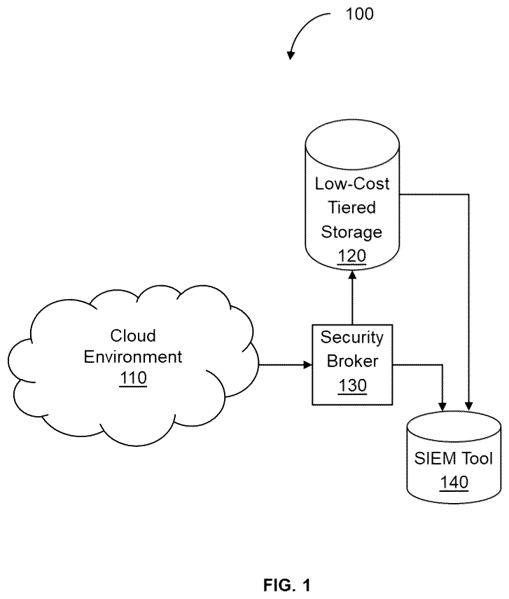

FIG. 1 shows an example network diagram 100 utilized to describe the various disclosed embodiments. In the example network diagram 100, there is a cloud environment 110, a security broker 130, low-cost tiered storage 120, and SIEM tool 140.

Cloud environment 110 is virtualized and distributed infrastructure that enables the delivery of computing resources, such as servers, storage, databases, networking, software, and analytics, over the internet. Cloud environment 110 may include any public, private, or hybrid cloud computing platform. Examples of public cloud computing platforms include Amazon Web Services (AWS), Microsoft Azure, Google Cloud Platform (GCP), IBM Cloud, and the like.

Cloud environment 110 generates cloud logs. A cloud log is a log file or record of events generated through various services that track activities within the cloud environment 110. As an illustrative example, in Amazon Web Services® (AWS®), CloudTrail® records detailed application programming interface (API) activity and user actions across the cloud environment 110, including who initiated a request, when it occurred, from which location, and the affected resources. CloudWatch® is another tool that captures logs, particularly related to the performance of serverless execution services, such as Elastic Compute Cloud® (EC2) instances or Lambda functions. EC2 instances are virtual machines that are used to run applications, and Lambda functions are serverless computer functions. Additionally, many AWS® services generate their own specific logs. For instance, Simple Storage Service® (S3) produces access logs to track requests made to containers (buckets) of data objects. S3 is a scalable object storage service.

Relational Database Service® (RDS) generates logs related to database activity. RDS provides managed database solutions and generates logs that track database activity, errors, and performance. Improper access controls or excessive permissions in RDS can lead to unauthorized data exposure or loss. Identity and Access Management (IAM) provides logs that document user actions and permissions management, and. As an example, Secrets Manager® is a service for managing sensitive information like API keys or database credentials. As another example, logs of IAM and Secretes Manager are generated by, for example, CloudTrail®. These are just some examples of cloud services or instances that can generate logs. The disclosed embodiments are applicable to any type of log regardless of the type of service, instance, device, application, or infrastructure generating the logs.

SIEM tool 140 is a tool that manages security information and events based on the real-time collection, storage, and analysis of log data from various systems, endpoints, applications, and network devices to identify and respond to potential security incidents. Examples of SIEM tools include Splunk Enterprise Security, ArcSight, Microsoft Sentinel, IBM QRadar, and the like.

In an embodiment, the low-cost tiered storage 120 is external to a storage of the SIEM tool. According to this embodiment, the low-cost tiered storage 120 is neither part of the SIEM tool nor operates under instructions by the SIEM tool. Low-cost tiered storage 120 is a storage service that classifies data into different “tiers” or levels based on the data's access frequency, value, and performance requirements. Each tier offers varying degrees of speed, cost, and storage characteristics to optimize data management. Low-cost tiered storage 120 may contain two or more tiers (e.g., hot, warm, and cold storage). In an embodiment, low-cost tiered storage 120 is cloud storage.

Security broker 130 is configured to receive cloud logs and classify the cloud logs based on level of security severity. Security broker 130 is configured to receive data from threat intelligence feeds and information about cloud environment 110. Based on this continually-received data, security broker 130 is configured to route cloud logs that are classified as having sufficiently high security severity to SIEM tool 140. Such cloud logs are stored in the SIEM tool 140. Additionally, security broker 130 is configured to route cloud logs that are classified as having insufficiently high security severity to low-cost tiered storage 120. In an embodiment, the security broker 130 may execute in the cloud environment 110.

In an embodiment, cloud logs have sufficiently high security severity when the event source of the cloud log is relevant for investigating a potential attack on a particular cloud environment 110. For example, a cloud log generated, for instance, from RDS, may indicate an authorized ingress, through a retired API, to a database. The description of the cloud log may list the types of methods of authorization that enables ingress to this group. In an embodiment, high security severity of a log may be determined based on a score.

When cloud environment 110 has critical assets on the database (in the above example), security broker 130 may classify the cloud log as of sufficiently high security severity. The cloud log is useful to capture the type of attack that may be occurring, which may be mapped to specific techniques in the MITRE ATT&CK framework. The event indicated in the cloud log in this example may be mapped to attack techniques like TA0005 (Defense Evasion); T1578 (Modify Cloud Compute Infrastructure). Further, security broker 130 may score the event as high severity, indicating that an attack may use the retired API to allow access to a database instance. Based on this mapping, security broker 130 may send the cloud log to be stored in the SIEM tool 140.

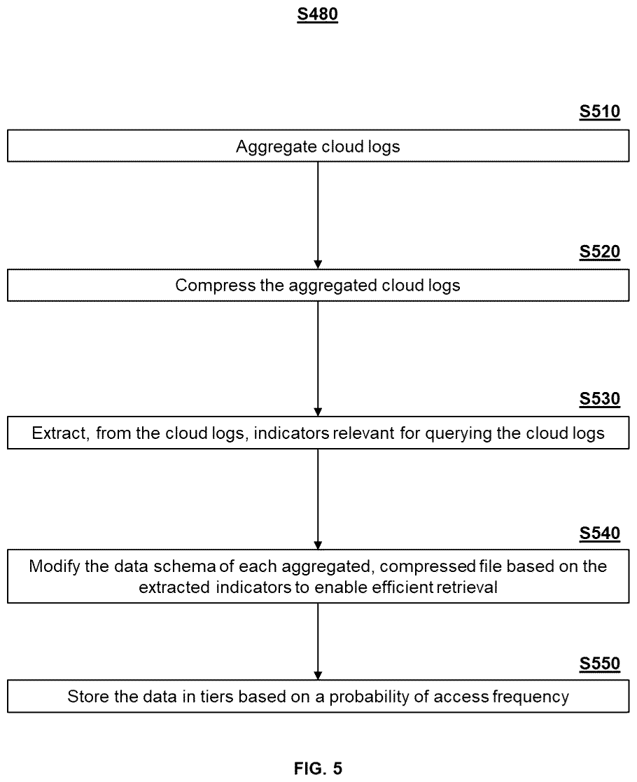

When the cloud environment 110 does not have any critical assets on the database (in the above example), the event captured in the cloud log may be classified as having insufficiently high security severity. The cloud log, based on this cloud environment, may be given a lower severity score than the cloud log in the cloud environment where the database stored critical assets. The cloud log, in this case, may be stored in low-cost tiered storage 120. Preparing logs to be saved in storage (e.g., low-cost tiered storage 120) is discussed in more detail hereinbelow, including with respect to FIG. 5.

In an embodiment, security broker 130 may utilize a machine learning (ML) model trained on threat intelligence feeds and various infrastructures of cloud environments, and various cloud logs to classify the security criticality of cloud logs.

In a further embodiment, security broker 130 may preserve, in the SIEM tool 140, cloud logs that are classified as having insufficiently high security severity when an organization uses the events captured in the cloud logs as part of the organization's automated security detection and response procedures. According to this embodiment, when an event captured in a cloud log is used as part of the organization's automated security detection and response procedures, the cloud log may be given a higher severity score than the cloud log would otherwise be given if the event the cloud log captures were not used by the organization as such. Automated security detections and response procedures refer to the processes or mechanisms used to identify, monitor, and respond to suspicious or malicious activities within an organization's information technology environment. These automated security detection and response procedures may be configured in a SIEM tool used by the organization.

In another embodiment, security broker 130 may forward and store, in the SIEM tool 140, cloud logs that are classified as having insufficiently high security severity when an organization's security team is using the events captured in the cloud logs in queries to the SIEM tool 140. According to this embodiment, when an event captured in a cloud log is used in a query by the security team, the cloud log may be given a higher severity score than the cloud log would otherwise be given if the event the cloud log captures were not used in the security team's queries.

Cloud logs stored in low-cost tiered storage 120 may be retrieved on-demand by security researchers of an organization to be stored and analyzed by SIEM tool 140. Preparation of logs to be saved in low-cost tiered storage 120 (as discussed with respect to FIG. 5) enables the on-demand retrieval of logs into SIEM tool 140 that are most relevant for security research.

It should be understood that the embodiments described herein are merely exemplary and not intended to be limiting. The arrangement illustrated in FIG. 1 is provided for illustrative purposes only and does not restrict the scope of the disclosed embodiments. Various modifications, adaptations, and alternative configurations may be implemented without departing from the spirit and scope of the disclosed embodiments.

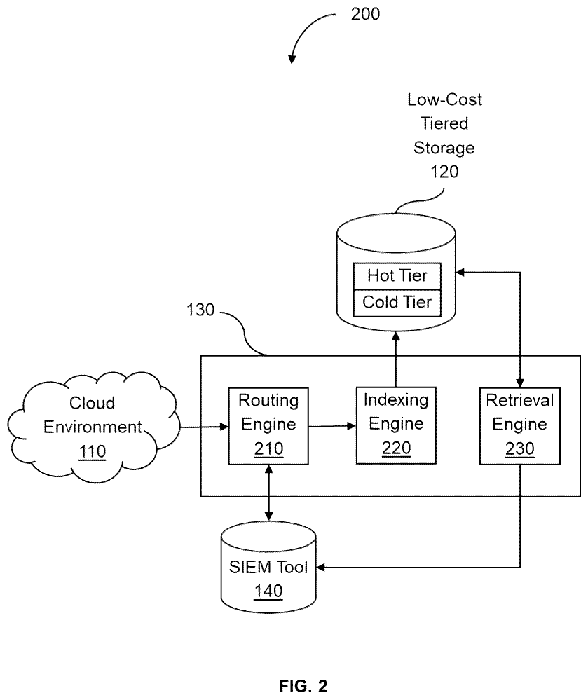

FIG. 2 is an example functional diagram 200 illustrating SIEM optimization according to an embodiment.

Routing engine 210 is configured to collect logs from the cloud environment 110 and route the collected logs to the SIEM tool 140 or to the indexing engine 220, which prepares the logs to be saved in low-cost tiered storage 120. Retrieval engine 230 is configured to allow a security team to retrieve, on demand, the most relevant logs from low-cost tiered storage 120 to answer the query.

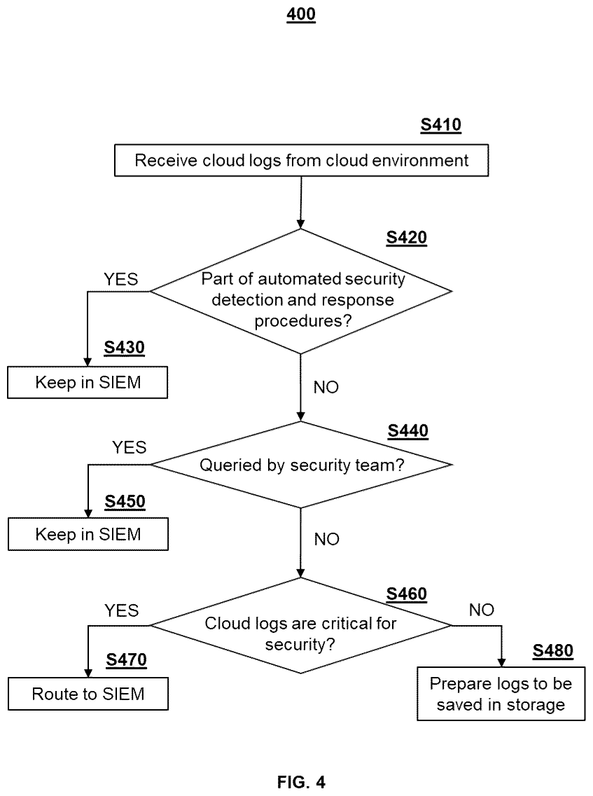

Routing engine 210 collects cloud logs from cloud environment 110. When the cloud logs are determined to have sufficiently high security severity, cloud logs are routed to the SIEM tool 140. When the cloud logs are determined to have insufficiently high security severity, cloud logs are sent to the indexing engine 220. In determining the level of security severity, a security score is computed, as described in more detail at S460, FIG. 4. When the computed security score of a cloud log is above a pre-determined threshold, the cloud log is determined to have a sufficiently high security severity. When the computed security score of a cloud log is below a pre-determined threshold, the cloud log is determined to have an insufficiently high security severity.

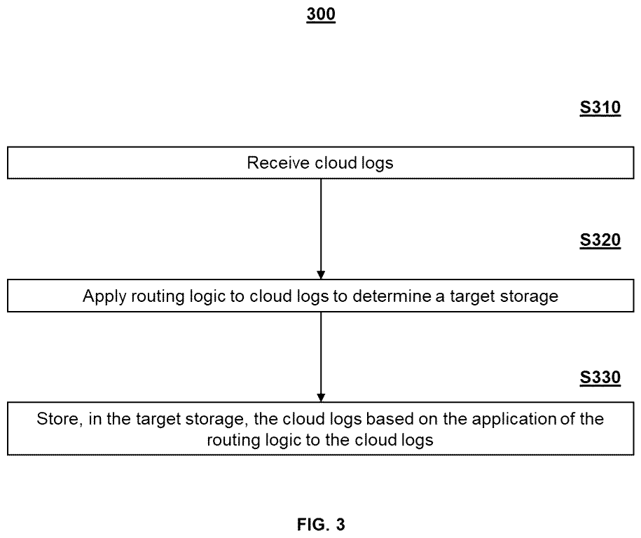

Additionally, routing engine 210 monitors data in the SIEM tool 140 to determine when the data is collected as part of an organization's automated security detection and response procedures or when the data is collected as part of a query by a security analyst of the organization. In an embodiment, routing engine 210 keeps such data stored in SIEM tool 140. Routing engine 210 collects updated threat intelligence feeds and information about the cloud environment 110 to determine any changes in security severity level of the cloud logs. This dynamic routing of cloud logs is discussed in more detail with respect to FIGS. 3 and 4.

Indexing engine 220 receives the logs that have insufficiently high security severity and prepares the logs to be saved in the storage in such a way as to allow for the most efficient, lowest cost retrieval of the logs by a security analyst. Indexing engine 220 aggregates and compresses the data into a single file, extracts indicators that are relevant for indexing the data, and modifies the schema and the storage tier to enable efficient retrieval of log data and quick response to a potential security threat. Preparation of the logs by the indexing engine 220 is discussed in more detail with respect to FIG. 5.

Retrieval engine 230 monitors which logs are accessed from low-cost tiered storage 120 and how frequently such logs are accessed. Based on access and frequency of access, the logs are stored in different tiers that correspond to how frequently a log is accessed by security analysts of an organization.

It should be understood that the engines, modules, and components described in reference to FIG. 2 may be implemented in software, firmware, hardware, or any combination thereof. In embodiments where the engines are implemented in software, they may comprise instructions stored on a non-transitory computer-readable medium and executed by one or more processors to perform the described functions. The scope of the disclosed embodiments is not limited to any particular implementation, and various modifications, adaptations, and equivalent arrangements may be made without departing from the disclosed embodiments.

FIG. 3 is an example flowchart 300 of a process for optimizing a SIEM tool according to an embodiment. In some embodiments, one or more process blocks of FIG. 3 may be performed by security broker 130, FIG. 1.

At S310, cloud logs are received. A cloud log is a log file or record of events generated through various services that track activities within a cloud environment (e.g., cloud environment 110, FIG. 1. Cloud logs are discussed in more detail in FIG. 1.

At S320, routing logic is applied to cloud logs to determine a target storage. The target storage may be a SIEM tool or a low-cost tiered storage. The applied routing logic is discussed in more detail herein with respect to security broker 130, FIG. 1, FIG. 2, and FIG. 4.

At S330, the cloud logs are stored in the target storage based on the application of the routing logic to the cloud logs. The target storage that the cloud logs are stored in is determined by the applied routing logic. When the applied routing logic determines that the target storage for a cloud log is a SIEM tool (at S320), the cloud log is stored in a SIEM tool. When the applied routing logic determines that the target storage for a cloud log is a low-cost tiered storage (at S320), the cloud log is stored in a low-cost tiered storage. Local storage, as discussed in more detail above, is a storage service that classifies data into different “tiers” or levels based on the data's access frequency, value, and performance requirements. Storing cloud logs based on applied routing logic is discussed in more detail herein.

Although FIG. 3 shows example blocks of flowchart 300, in some implementations, flowchart 300 may include additional blocks, fewer blocks, different blocks, or differently arranged blocks than those depicted in FIG. 3. Additionally, or alternatively, two or more of the blocks of flowchart 300 may be performed in parallel.

FIG. 4 is an example flowchart 400 illustrating a process for dynamic routing of logs to SIEM tool according to an embodiment. In an embodiment, dynamic routing of logs may be executed by security broker 130, FIG. 1.

At S410, cloud logs are received from the cloud environment. Cloud logs are defined and discussed in more detail hereinabove, with respect to cloud environment 110, FIG. 1 and security broker 130, FIG. 1. In an embodiment, log data collected by a SIEM tool is also collected to determine whether the log data should be kept in a SIEM tool or moved to storage.

At S420, it is determined whether log data collected by a SIEM tool is collected as part of an organization's automated security detection and response procedures. If YES, execution proceeds with S430. If NO, execution proceeds with S440. Automated security detection and response procedures are defined hereinabove with respect to security broker 130, FIG. 1.

At S430, the collected log data is kept in a SIEM tool. In an embodiment, the collected log data is kept in the SIEM tool to allow the organization to have access, in the organization's SIEM tool, to log data that is required to operate the organization's automated security detection and response procedures.

At S440, it is determined whether log data collected by a SIEM tool is part of a security analyst's query. If YES, execution proceeds with S450. If NO, execution proceeds with S460. In an embodiment, SIEM query history is received to determine which queries are executed by an organization's security analysts.

In an embodiment, based on the logs that are queried, a correlation graph for logs is constructed. According to this embodiment, nodes may represent log events and edges may represent sufficiently significant relationships between logs (e.g., temporal proximity, shared indicators, process lineage, or communication paths).

In some embodiments, this correlation graph may be constructed using machine learning models and graph algorithms to infer correlations between queried logs. These inferred correlations may be used to extrapolate potential future queried logs, even for logs that have not yet been queried.

At S450, the collected log data is kept in a SIEM tool. In an embodiment, the collected log data is kept in the SIEM tool to allow the organization to have access, in the organization's SIEM tool, to log data that is relevant for answering security analysts' queries. For example, if a security analyst queries RDS events frequently, the logs that capture such RDS events are kept in the SIEM even though the log may be classified (at S360) as having insufficiently high security severity.

At S460, it is determined whether the cloud logs received from the cloud environment are of sufficiently high security severity. If YES, execution proceeds with S470. If NO, execution proceeds with S480. Determining security severity of cloud logs is discussed in more detail hereinabove with respect to security broker 130, FIG. 1. Determining security severity is based on computed security scores. Scores above a pre-determined threshold have sufficiently high security severity, and scores below a pre-determined threshold have insufficiently high security severity.

In an embodiment, threat intelligence feeds and information about the cloud environment 110 are continually collected to compute updated security scores to determine any changes in the security severity level of the cloud logs. Continual collection of new security data from the threat intelligence feeds and information about the cloud environment 110 serves to maximize security-relevant information to enable accurate mapping of events capture in cloud logs to potential security incidents for an organization.

At S470, the cloud logs that have a sufficiently high security severity are routed to a SIEM tool. Routing cloud logs with sufficiently high security severity to a SIEM tool used by an organization gives the organization greater visibility into the most relevant logs and reduces the amount of logs stored in the organization's SIEM, providing significant computation cost savings.

At S480, cloud logs are prepared to be saved in storage. Preparing cloud logs to be saved in storage enables efficient retrieval of relevant logs by security teams and allows for quicker responses to security incidents. Preparing cloud logs to be saved in storage is discussed in more detail hereinbelow with respect to FIG. 5.

Although FIG. 4 shows example blocks of flowchart 400, in some implementations, flowchart 400 may include additional blocks, fewer blocks, different blocks, or differently arranged blocks than those depicted in FIG. 4. Additionally, or alternatively, two or more of the blocks of flowchart 400 may be performed in parallel.

FIG. 5 is an example flowchart 500 illustrating a process for preparing cloud logs for storage to enable efficient retrieval of the cloud logs according to an embodiment. In an embodiment, preparing cloud logs for storage may be executed by security broker 130, FIG. 1.

At S510, cloud logs are aggregated. In an embodiment, cloud logs are aggregated into a single file when the size (e.g. amount) of a set of cloud logs reaches a pre-determined threshold. According to this embodiment, aggregation of each set of cloud logs is performed for each set of cloud logs whose size reaches the pre-determined threshold. In an embodiment, the set of cloud logs whose size is determined to reach a pre-determined threshold is a set of cloud logs of the same type. According to this embodiment, aggregation is performed for cloud logs of the same type.

Additionally, when the size of a set of cloud logs is below the pre-determined threshold, cloud logs may be aggregated into a single file when a certain time threshold is met (e.g., at a pre-determined time threshold).

At S520, the aggregated cloud logs are compressed. In an embodiment, the cloud logs are compressed into a columnar storage file format such as, but not limited to, Parquet®. According to this embodiment, data of the cloud logs is stored in columns. Each column contains the same semantic type of data. Storing the data in a single column-based file format serves to reduce the size of the data that is stored. In some embodiments, additional compression algorithms may be applied to the column-based file formats to reduce the overall file size.

At S530, indicators relevant for querying the cloud logs are extracted from the cloud logs. An indicator is a data point in the cloud logs that is relevant for querying data in the cloud logs. For example, in the case when many event logs are generated and the logs indicate that there are three IP addresses as the source of the logs, the IP address may be an indicator relevant for querying the data.

In an embodiment, other indicators are extracted including, but not limited to, date, hour, second, time zone, region associated with an event, and the cloud provider account the event is associated with. In an additional embodiment, aggregations, such as, but not limited to, which events exist in the cloud log and are extracted from each log.

At S540, data schema of each aggregated, compressed file is modified based on the extracted indicators to enable efficient retrieval. The original data schema of the cloud logs varies based on the type of cloud logs. In an embodiment, the original data schema of each file is a JavaScript Object Notation (JSON) format. The data schema of each aggregated, compressed file of the cloud logs is a columnar file format. Modifying the data schema of each aggregated, compressed file includes adding extracted indicators from the corresponding cloud logs as columns in the respective column-based file. In an embodiment, modifying the data schema of each aggregated, compressed file includes adding partitioning columns in the each file. In another embodiment, modifying the data schema of each aggregated, compressed file includes adding columns that include information on security relevancy, e.g., a computed security score, of the data stored in each file.

In another embodiment, modifying the data schema includes adding the time-based indicators, detailed above at S530, as columns. For example, data is stored, based on the time of each event in the file, into folders, each corresponding to year, month, and day. According to this embodiment, modifying the data schema according to time-based indicators enables more efficient retrieval of the most relevant files corresponding to a particular time in which an event occurred.

At S550, data is stored in tiers based on a probability of access frequency of the data. In an embodiment, tiers are used to store data based on, but not limited to, the frequency of access of the data. Primary storage (e.g., hot storage) is designed to store data that is frequently accessed. Secondary storage (e.g., warm storage) is designed to store data that is less frequently accessed than data in primary storage but still needs to be available relatively quickly. Archival storage (e.g., cold storage) is designed for data that is rarely accessed.

In an embodiment, probabilities of access frequency of the data is determined based on patterns of information used in queries by security analysts of an organization. For example, indicators or other information used frequently in queries may suggest a pattern of high demand for data that answers these queries and may indicate a high probability of access frequency. Data relevant for answering such queries may be stored in a hot or warm storage tier based on the probability.

Although FIG. 5 shows example blocks of flowchart 500, in some implementations, flowchart 500 may include additional blocks, fewer blocks, different blocks, or differently arranged blocks than those depicted in FIG. 5. Additionally, or alternatively, two or more of the blocks of flowchart 500 may be performed in parallel.

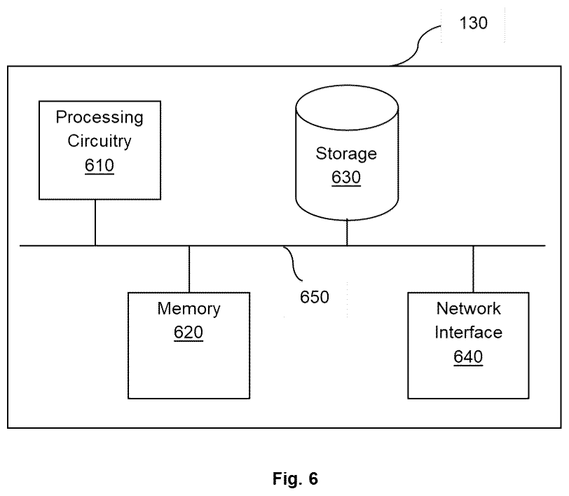

FIG. 6 is an example schematic diagram of a security broker 130 according to an embodiment. The security broker 130 includes a processing circuitry 610 coupled to a memory 620, a storage 630, and a network interface 640. In an embodiment, the components of the security broker 130 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 640 allows the security broker 130 to communicate with other systems, devices, components, applications, or other hardware or software components, for example, as described herein.

It should be understood that the embodiments described herein are not limited to the specific architecture illustrated in FIG. 6, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

1. A method for optimizing a security information and event management (SIEM) tool, comprising:
receiving cloud logs, wherein the cloud logs are logs of events captured from a cloud environment;
receiving security data from threat intelligence feeds and information on the cloud environment;
receiving, from the SIEM tool, SIEM query history including records of queries previously executed by security analysts of an organization using the SIEM tool;
determining a routing logic to be applied to the cloud logs based on the SIEM query history, including, for each cloud log, by:
determining, based on the records of the queries, whether an event captured in the cloud log was used in at least one of the queries previously executed using the SIEM tool;
computing a security severity score for the cloud log on the security data and the information on the cloud environment; and
in response to determining that the event captured in the cloud log was used in the at least one of the queries previously executed using the SIEM tool, increasing the computing security severity score for the cloud log;
applying the routing logic to each cloud log to determine a target storage, wherein a target storage includes either the SIEM tool or a low-cost tiered storage, and wherein the low-cost tiered storage is external to the SIEM tool;
for each cloud log, routing the cloud log to the SIEM tool when resulting computed security severity score for the cloud log exceeds a pre-determined threshold; and
for each cloud log, routing the cloud log to the low-cost tiered storage when the resulting computed security severity score for the cloud log exceeds the pre-determined threshold.

2. The method of claim 1, wherein applying the routing logic is further based on security detection and response procedures.

3. (canceled)

4. The method of claim 1, further comprising:
updating the computed security severity score of each cloud log based on newly received security data from threat intelligence feeds and information on the cloud environment.

5. The method of claim 1, wherein routing the cloud logs to the low-cost tiered storage further comprises:
for cloud logs of the same type, aggregating a set of cloud logs when a size of cloud logs in the set reaches a pre-determined threshold;
compressing each aggregated set of cloud logs into at least one file, wherein the at least one file is a column-based file;
extracting indicators relevant for querying the cloud logs;
modifying a schema of the cloud logs based on the extracted indicators to enable efficient retrieval of the cloud logs from the low-cost tiered storage; and
storing the cloud logs in tiers, wherein the tiers store cloud logs based on probabilities of frequency of access of the cloud logs, wherein the probabilities of frequency of access of the cloud logs are computed based at least in part on determined patterns in queries.

6. The method of claim 5, wherein the extracted indicators include time-based indicators and location-based indicators associated with data in the cloud logs.

7. The method of claim 5, wherein storing the cloud logs in tiers further comprises:
when the computed probability of frequency of access of the cloud log is sufficiently high, storing the cloud log in a first tier; and
when the computed probability of frequency of access of the cloud log is insufficiently high, storing the cloud log in a second tier.

8. The method of claim 2, wherein applying the routing logic to cloud logs to determine a target storage, where the routing logic is based on security detection and response procedures, further comprises:
determining when a set of cloud logs collected by a SIEM tool is collected as part of an organization's security incidents and response procedures; and
when a set of cloud logs collected by a SIEM tool is collected as part of an organization's security incidents and response procedures, keeping the set of cloud logs in the SIEM tool.

9. The method of claim 1, wherein applying the routing logic to cloud logs to determine a target storage, where the routing logic is based on an organization's querying history, further comprises:
determining when a set of cloud logs collected by the SIEM tool is part of at least one query previously submitted to the SIEM tool; and
when a set of cloud logs collected by the SIEM tool is part of at least one query, keeping the set of cloud logs in the SIEM tool.

10. The method of claim 1, wherein the routing logic is applied using a machine learning (ML) model trained on security data from threat intelligence feeds and information about a plurality of cloud environments.

11. A non-transitory computer-readable medium storing a set of instructions for optimizing a security information and event management (SIEM) tool, the set of instructions comprising:
one or more instructions that, when executed by one or more processors of a device, cause the device to:
receive cloud logs, wherein the cloud logs are logs of events captured from a cloud environment;
receive security data from threat intelligence feeds and information on the cloud environment;
receive, from the SIEM tool, SIEM query history including records of queries previously executed by security analysts of an organization using the SIEM tool;
determine a routing logic to be applied to the cloud logs based on the SIEM query history, including, for each cloud log, by:
determining, based on the records of the queries, whether an event captured in the cloud log was used in at least one of the queries previously executed using the SIEM tool;
computing a security severity score for the cloud log based on the security data and the information on the cloud environment; and
in response to determining that the event captured in the cloud log was used in the at least one of the queries previously executed using the SIEM tool, increasing the computing security severity score for the cloud log;
apply the routing logic to each cloud log to determine a target storage, wherein a target storage includes either the SIEM tool or a low-cost tiered storage, and wherein the low-cost tiered storage is external to the SIEM tool;
for each cloud log, route the cloud log to the SIEM tool when the resulting computed security severity score for the cloud log exceeds a pre-determined threshold; and
for each cloud log, route the cloud log to the low-cost tiered storage when the resulting computed security severity score for the cloud log exceeds the pre-determined threshold.

12. A system for optimizing a security information and event management (SIEM) tool comprising:
a processing circuitry;
a memory, the memory containing instructions that, when executed by the processing circuitry, configure the system to:
receive cloud logs, wherein the cloud logs are logs of events captured from a cloud environment;
receive security data from threat intelligence feeds and information on the cloud environment;
receive, from the SIEM tool, SIEM query history including records of queries previously executed by security analysts of an organization using the SIEM tool;
determine a routing logic to be applied to the cloud logs based on the SIEM query history, including, for each cloud log, by:
determining, based on the records of the queries, whether an event captured in the cloud log was used in is part of at least one of the queries previously executed using to the SIEM tool;
computing a security severity score for the cloud log based on the security data and the information on the cloud environment; and
in response to determining that the event captured in the cloud log was used in the at least one of the queries previously executed using the SIEM tool, increasing the computing security severity score for the cloud log;
apply the routing logic to each cloud log to determine a target storage, wherein a target storage includes either the SIEM tool or a low-cost tiered storage, and wherein the low-cost tiered storage is external to the SIEM tool;
for each cloud log, route the cloud log to the SIEM tool when the resulting computed security severity score for the cloud log exceeds a pre-determined threshold; and
for each cloud log, route the cloud log to the low-cost tiered storage when the resulting computed security severity score for the cloud log exceeds the pre-determined threshold.

13. The system of claim 12, wherein applying the routing logic is further based on security detection and response procedures.

14. (canceled)

15. The system of claim 12, wherein the memory contains further instructions which when executed by the processing circuitry further configure the system to:
update the computed security severity score of each cloud log based on newly received security data from threat intelligence feeds and information on the cloud environment.

16. The system of claim 12, wherein the memory contains further instructions that, when executed by the processing circuitry for routing the cloud logs to the low-cost tiered storage, further configure the system to:
for cloud logs of the same type, aggregate a set of cloud logs when a size of cloud logs in the set reaches a pre-determined threshold;
compress each aggregated set of cloud logs into at least one file, wherein the at least one file is a column-based file;
extract indicators relevant for querying the cloud logs;
modify a schema of the cloud logs based on the extracted indicators to enable efficient retrieval of the cloud logs from the low-cost tiered storage; and
store the cloud logs in tiers, wherein the tiers store cloud logs based on probabilities of frequency of access of the cloud logs, wherein the probabilities of frequency of access of the cloud logs are computed based at least in part on determined patterns in queries.

17. The system of claim 16, wherein the memory contains further instructions that, when executed by the processing circuitry for storing the cloud logs in tiers, further configure the system to:
when the computed probability of frequency of access of the cloud log is sufficiently high, store the cloud log in a first tier; and
when the computed probability of frequency of access of the cloud log is insufficiently high, store the cloud log in a second tier.

18. The system of claim 13, wherein the memory contains further instructions that, when executed by the processing circuitry for applying the routing logic to cloud logs to determine a target storage, where the routing logic is based on security detection and response procedures, further configure the system to:
determine when a set of cloud logs collected by a SIEM tool is collected as part of an organization's security incidents and response procedures; and
when a set of cloud logs collected by a SIEM tool is collected as part of an organization's security incidents and response procedures, keep the set of cloud logs in the SIEM tool.

19. The system of claim 13, wherein the memory contains further instructions that, when executed by the processing circuitry for applying the routing logic to cloud logs to determine a target storage, where the routing logic is based on an organization's querying history, further configure the system to:
determine when a set of cloud logs collected by the SIEM tool is part of at least one query previously submitted to the SIEM tool; and
when a set of cloud logs collected by the SIEM tool is part of at least one query, keep the set of cloud logs in the SIEM tool.

20. The system of claim 12, wherein the routing logic is applied using a machine learning (ML) model trained on security data from threat intelligence feeds and information about a plurality of cloud environments.
